(19) United States
(12) Patent Application Publication
(10) Pub. No.: US 2015/0036839 A1
(43) Pub. Date: Feb. 5, 2015

(54) MICROPHONE FOR VEHICLE

(71) Applicant: Hyundai Motor Company, Seoul (KR)

(72) Inventor: Yong Sik CHO, Anyang-si (KR)

(73) Assignee: HYUNDAI MOTOR COMPANY, Seoul (KR)

(21) Appl. No.: 14/098,293

(22) Filed: Dec. 5, 2013

(30) Foreign Application Priority Data
Jul. 30, 2013 (KR) 10-2013-0090132

(51) Int. Cl. H04R 1/08; H04R 1/02

(52) U.S. Cl. CPC H04R 1/08; H04R 1/021
USPC 381/86

(57) ABSTRACT

A microphone for a vehicle includes an opening configured to disperse wind pressure and a filter configured to prevent vibration due to the wind pressure introduced through the opening. A holder is fixed onto a printed circuit board (PCB) to thereby prevent resonance due to the pressure of the wind passing through the filter, and the PCB is configured to convert a sound wave into an electrical signal.

### CROSS-REFERENCE TO RELATED APPLICATION

This application is based on and claims the benefit of priority to Korean Patent Application No. 10-2013-0090132, filed on Jul. 30, 2013 in the Korean Intellectual Property Office, the disclosure of which is incorporated herein in its entirety by reference.

### TECHNICAL FIELD

The present disclosure relates to a microphone for a vehicle, and more particularly, to a microphone for a vehicle which is resistant to wind noise.

### BACKGROUND

In view of the very high present traffic accident rate, talking on a mobile phone while driving increases probability of an occurrence of traffic accidents. In practice, it is known through reports of media sources or the like that a large number of drivers have experienced a traffic accident while talking on a mobile phone.

Therefore, it is necessary for a call sender to confirm whether or not a call receiver is driving, and refrain from calling if the call receiver is driving.

Hands-free communication devices capable of decreasing the traffic accident rate and still enabling the telephone call to be received have recently been mounted in vehicles. Therefore, a driver can call using a microphone mounted in an interior of the vehicle while driving.

A microphone for a vehicle according to the related art has an opening of a grill structure, therefore, it may not disperse wind pressure and may not prevent vibration of a microphone element due to the wind introduced through the opening. In addition, the microphone for the vehicle may not prevent resonance due to the wind introduced through the opening.

As a result, since the microphone for the vehicle has a weak structure in blocking noise caused by wind pressure when the wind is strongly introduced into the microphone, plosive is generated, thereby degrading recognition performance of the microphone.

### SUMMARY

The present disclosure has been made to solve the above-mentioned problems occurring in the prior art while advantages achieved by the prior art are maintained intact.

An aspect of the present disclosure provides a microphone for a vehicle capable of dispersing pressure of wind and preventing vibration of a microphone element due to the introduced wind.

Another aspect of the present disclosure provides a microphone for a vehicle capable of dispersing pressure of wind and preventing vibration of a microphone element and resonance in the microphone due to the introduced wind.

Exemplary embodiments of the present disclosure are not limited to the above-mentioned subject, other subjects and advantages of the present disclosure which are not mentioned can be appreciated by the following description and will be clearly described by exemplary embodiments of the present disclosure. In addition, it will be easily known that the subjects and advantages of the present disclosure can be implemented by means and a combination thereof shown in the appended claims.

According to an exemplary embodiment of the present disclosure, a microphone for a vehicle includes an opening configured to disperse wind pressure and a filter configured to prevent vibration due to the wind pressure introduced through the opening. A holder is fixed onto a printed circuit board (PCB) to thereby prevent resonance due to the wind pressure passing through the filter, and the PCB is configured to convert a sound wave into an electrical signal.

In another aspect of the present disclosure, a microphone for a vehicle includes an opening configured to disperse wind pressure, and a filter configured to prevent vibration due to the wind pressure introduced through the opening. A holder is fixed onto a printed circuit board (PCB), and the PCB is configured to convert a sound wave into an electrical signal.

### BRIEF DESCRIPTION OF THE DRAWINGS

The above and other objects, features and advantages of the present disclosure will be more apparent from the following detailed description taken in conjunction with the accompanying drawings.

FIG. 1 is an exploded view of a microphone for a vehicle according to an exemplary embodiment of the present disclosure.

FIG. 2a is a view of analyzing performance of a microphone for a vehicle according to the related art.

FIG. 2b is a view of analyzing performance of a microphone for a vehicle according to an exemplary embodiment of the present disclosure.

FIG. 3 is a view illustrating a standard type holder used in the present disclosure.

### DETAILED DESCRIPTION

The above objects, features, and advantages will be apparent by a detailed description described below in detail with reference to the accompanying drawings, and therefore, the technical ideas of the present disclosure can be easily practiced by a person with ordinary skill in the art to which the present disclosure pertains. In addition, in describing the present disclosure, when a detailed description of well-known technology relating to the present disclosure may unnecessarily obscure the spirit of the present disclosure, a detailed description thereof will be omitted. Hereinafter, exemplary embodiments of the present disclosure will be described in detail with reference to the accompanying drawings.

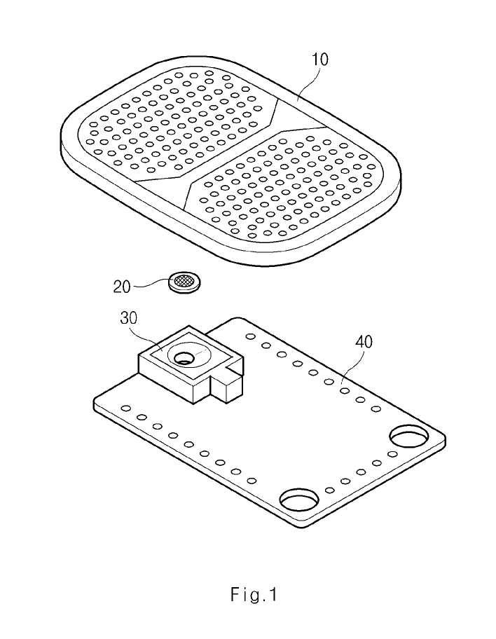

FIG. 1 is an exploded view of a microphone for a vehicle according to an exemplary embodiment of the present disclosure.

As shown in FIG. 1, the microphone for the vehicle according to an exemplary embodiment of the present disclosure includes an opening 10, a filter 20, a holder 30, and a printed circuit board 40.

The above-mentioned respective components will be described. The opening 10 is implemented in a comb shape, the comb shape having a plurality of holes to thereby disperse wind pressure having a negative influence on the microphone.

Generally, the wind pressure generates irregular plosive at a low frequency or a high frequency, thereby causing a performance degradation of the microphone.

In order to prevent this, the present disclosure implements the opening 10 as a comb shape, the comb shape having a plurality of holes. In this case, the comb shape, which is a shape having the plurality of holes densely arranged as shown in FIG. 1, in which the holes have a circular shape.

The filter 20, which in certain embodiments (or net-shaped) is a mesh-shaped filter, prevents vibration of a microphone element due to the wind pressure introduced through the opening 10.

Here, the vibration caused by the wind pressure is different from vibration caused by sound pressure. The vibration caused by sound pressure, which is necessary to operate the microphone normally, is not prevented by the mesh-shaped filter.

Generally, the microphone has a dust-proof filter made of a non-woven fabric material for filtering foreign materials. The above-mentioned dust-proof filter may not prevent the vibration caused by the wind pressure. However, the mesh-shaped filter may prevent dust-proof and vibration due to the wind pressure.

The holder 30, which is a tapered holder having a hole gradually tapered from one surface to an opposite surface, is fixed onto the PCB 40 to thereby prevent an occurrence of resonance due to the wind pressure passing through the filter 20. The PCB 40 converts a sound wave into an electrical signal.

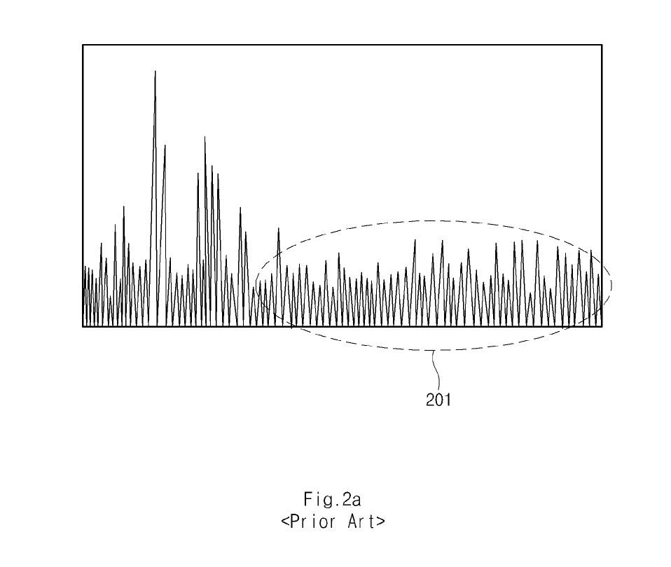

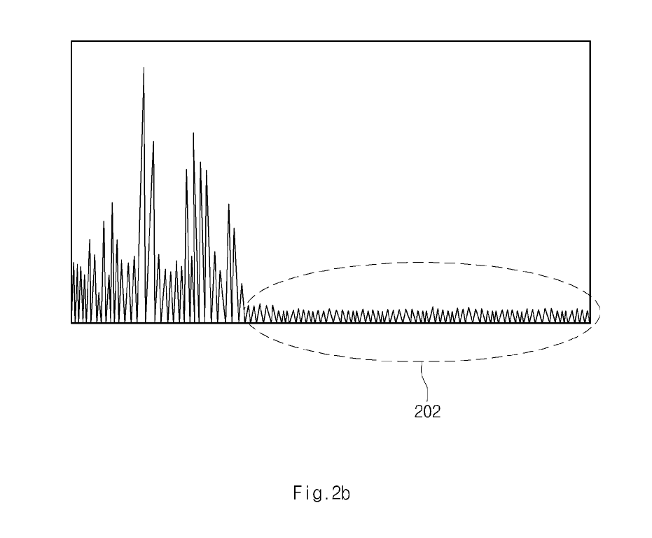

Hereinafter, performance of the microphone for the vehicle according to an exemplary embodiment of the present disclosure will be described with reference to FIGS. 2a and 2b.

FIG. 2a, which is a view of analyzing performance of a microphone for a vehicle according to the related art having a grill shaped opening, a filter made of a non-woven fabric material, and a standard type holder, and shows plosive caused by the wind pressure on a frequency domain. It may be appreciated in FIG. 2a that a significant number of plosives 201 are generated.

However, as shown in FIG. 2b, it may be appreciated that the microphone for the vehicle according to an exemplary embodiment of the present disclosure hardly generates plosives 202.

This is provided in detail in Table 1 below.

TABLE 1

| | | VOICE | | |
|---|---|---|---|---|
| | ENERGY | INFORMATION | ATTENUATION | |
| FREQUENCY | (%) | (%) | EFFECT | |
| 100~500 | 60 | 5 | 15~18 | dB |
| 500~1000 | 35 | 35 | 3~6 | dB |
| 1000~2000 | 3 | 35 | 3 | dB |

| | | | |
|---|---|---|---|
| 2000~4000 | 1 | 13 | — |
| 4000~8000 | 1 | 12 | — |

As a result, as represented in Table 1, it may be appreciated that the microphone for the vehicle according to an exemplary embodiment of the present disclosure has a significant attenuation effect.

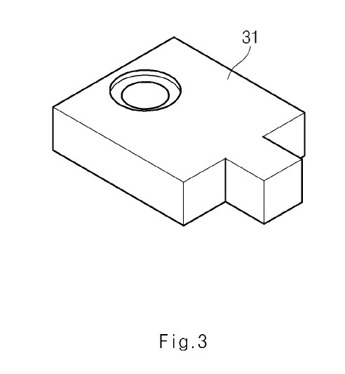

As another exemplary embodiment of the present disclosure, the holder 30 may use a standard type holder 31 as shown in FIG. 3. However, performance of the standard type holder 31 may be lower than that of the tapered holder 30.

As set forth above, according to an exemplary embodiment of the present disclosure, the wind pressure may be dispersed, and the vibration of the microphone element due to the introduced wind may be prevented.

In addition, according to an exemplary embodiment of the present disclosure, the wind pressure may be dispersed, and the vibration of the microphone element and the resonance in the microphone due to introduced wind may be prevented.

Although the exemplary embodiment of the present disclosure describes the microphone for the vehicle as an example, but the present disclosure is not limited thereto.

The present disclosure described above may be variously substituted, altered, and modified by those skilled in the art to which the present disclosure pertains without departing from the scope and spirit of the present disclosure. Therefore, the present disclosure is not limited to the above-mentioned exemplary embodiments and the accompanying drawings.

What is claimed is:

1. A microphone for a vehicle, comprising:
an opening configured to disperse wind pressure;
a filter configured to prevent vibration due to the wind pressure introduced through the opening;
a holder fixed onto a printed circuit board (PCB) to thereby prevent resonance due to the wind pressure passing through the filter, wherein
the PCB is configured to convert a sound wave into an electrical signal.

2. The microphone for the vehicle according to claim 1, wherein the opening has a comb shape, the comb shape having a densely arranged plurality of holes.

3. The microphone for the vehicle according to claim 1, wherein the filter is a mesh-shaped filter.

4. The microphone for the vehicle according to claim 1, wherein the holder is a tapered holder, the tapered holder having a hole gradually tapered from one surface to an opposite surface.

5. A microphone for a vehicle, comprising:
an opening configured to disperse wind pressure;
a filter configured to prevent vibration due to the wind pressure introduced through the opening;
a holder fixed onto a printed circuit board (PCB), wherein
the PCB is configured to convert a sound wave into an electrical signal.

6. The microphone for the vehicle according to claim 5, wherein the opening has a comb shape, the comb shape having a densely arranged plurality of holes.

7. The microphone for the vehicle according to claim 5, wherein the filter is a mesh-shaped filter.
